(19) United States
(12) Patent Application Publication
(10) Pub. No.: US 2006/0169394 A1
(43) Pub. Date: Aug. 3, 2006

(54) Apparatus and method for the helical winding of a reinforcing element onto a pneumatic tire blank

(76) Inventors: Jorn Seevers, Burgdorf (DE); Marko Drews, Hannover (DE)

Correspondence Address: ROBERT W. BECKER & ASSOCIATES;Suite B, 707 Highway 66, Tijeras, NM, 87059, US

(21) Appl. No.: 11/324,741

(22) Filed: Jan. 3, 2006

Related U.S. Application Data
(63) Continuation-in-part of application No. 10/313,711, filed on Dec. 6, 2002.

(30) Foreign Application Priority Data
Dec. 7, 2001 (DE) 101 60 249.9-16

(51) Int. Cl. B29D 30/00

(52) U.S. Cl. 156/117; 156/397

(57) ABSTRACT

An apparatus and method are provided for the helical winding of an essentially band or strip-shaped reinforcing element onto at least one ply of a pneumatic tire blank. The apparatus includes a rotating tire or belt build-up drum, a winding wheel disposed upstream of the drum and connected with devices for applying tension to the reinforcing element, and sensors that detect the position of the reinforcing element on the winding wheel, and the tension applied to the reinforcing element, and convey these values to a control device. The winding wheel is connected with a motor for driving or slowing the winding wheel, whereby at least two tensioning and guide rollers are radially spaced relative to the winding wheel such that the reinforcing element, which is guided over the winding wheel, forms a defined looping angle.

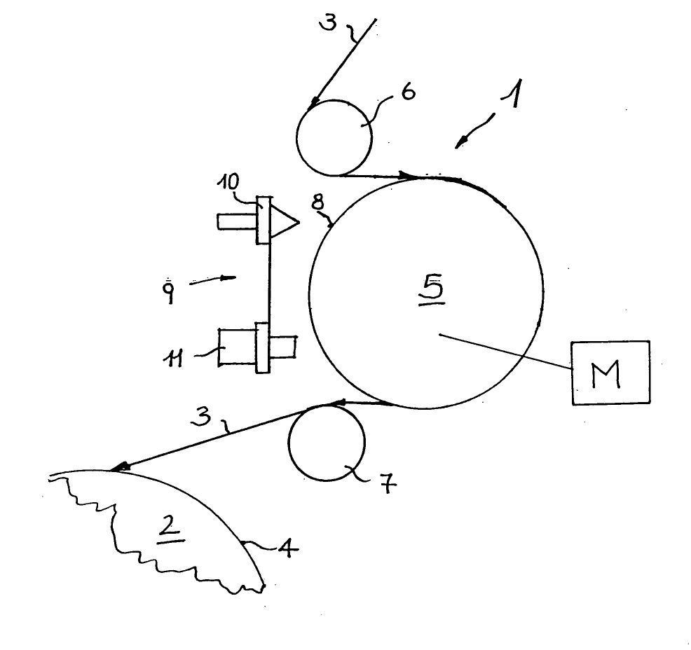

This application claims the priority of German application 101 60 249.9-16 filed Dec. 7, 2001 and is a continuation-in-part of pending application Ser. No. 10/313,711 filed Dec. 6, 2002

### BACKGROUND OF THE INVENTION

The present invention relates to an apparatus for the helical winding of an essentially band-shaped reinforcing element, especially a band or strip, onto at least one ply of a pneumatic tire blank, with the apparatus including a rotating tire or belt build-up drum, a winding wheel that is disposed upstream of the drum and that is connected with means for applying tension to the reinforcing element, and sensors that detect the position of the reinforcing element upon the winding wheel, and the tension applied to the reinforcing element, and convey these values to a control device. The present invention also relates to a method for the helical winding of an essentially band-shaped reinforcing element onto at least one ply of a pneumatic tire blank, according to which the reinforcing element is wound onto a rotating tire belt build-up drum via a winding wheel, whereby defined tension is applied to the reinforcing element, especially by slowing the reinforcing element down during the winding onto the tire or belt build-up drum, whereby the tension applied to the reinforcing element is measured and is maintained or varied in conformity with prescribed parameters.

In the context of the present invention, in general, the term reinforcing element refers to a filamentary, band-shaped or strip-shaped structure, which alone is intended to impart the necessary rigidity to the tire during a driving operation, in other words, generally functions as a belt beneath the tread strip and over the carcass ply, and is formed as a filament or cord of high-strength material, such as steel cord or aramid cord, or the reinforcing element is embodied as a band that covers the actual belt ply and ensures the positioning thereof, especially in the critical edge regions of the belt. Bands of this type are generally made of steel cords and filaments, of aramid, of polyester, nylon, or polyamide fibers and cords, whereby in each case a plurality of individual cords, for example 2-10, are combined into a strip that is embedded in rubber or in a rubber mixture.

A winding of, for example, a band is effected in such a way that the strips or filaments, when viewed ideally, assume an angle of nearly 0° relative to the circumferential direction of the tire. However, since the filaments are spirally or helically wound about the tire, and are disposed parallel to one another, slight deviations from the ideal 0° angle result, so that in practice angles of 1 to 10° are obtained.

With conventional winding apparatus and methods, however, other topographies and patterns of bands and other reinforcements upon the tire are also obtained, for example meandering shapes, cross ply structures, angle plies, and the like.

Especially in the area of so-called high performance tires, in other words motor vehicle tires having special requirements with regard to fitness for high speeds, tire uniformity, ability to withstand stress, emergency-running characteristics, and the like, bands and other reinforcing elements having varying tension over the width of the tread strip of the tire are wound on. For example, it can be desirable to wind the band with a higher tension about the edges of the belt than in the zenith portion of the belt, which may also be useful for compensating for expansion tension in the zenith portion during the expansion of the tire.

With other tires, the exact opposite may be desirable; in other words, in such a situation the reinforcing element can be applied with greater tension in the zenith region.

With these apparatus and methods the precise and repeatable application of tension to the reinforcing element is problematic. For example, it is known from EP 0 976 537 A3 to press retardation rollers against the reinforcing element to obtain different tensions.

An apparatus and method of the aforementioned general type is known from EP 0 288 609 B1 and EP 0 344 928 A2. Also here retardation means and sensors and control means connected therewith are used to apply tension to the reinforcing element.

Although it is possible with these known apparatus to apply tension to the reinforcing element, it is a problem, if necessary, to wind the reinforcing element onto the tire blank without tension if a tension was previously applied. Stated differently, the exact regulation of tensioning and untensioning of the reinforcing element has not previously been available in a satisfactory manner. A further problem is that when starting the heretoforeknown apparatus, it is not possible to achieve a winding of the reinforcing element that is free of tension, since when starting known apparatus varying tensions are always applied to the reinforcing element. The reason for this is that when starting such apparatus, the tire or belt build-up drum is rotated, whereby the reinforcing element begins to wind onto the ply or tire or belt build-up drum, whereas the non-driven winding wheel remains in its rest position until the inertia of the winding wheel is overcome and it begins to rotate. Thus, in this phase tension occurs on the reinforcing element that can be controlled, if at all, only with great difficulty.

It is therefore an object of the present invention to provide an apparatus and process of the aforementioned general type by means of which tensions applied to the reinforcing element can be controlled and adjusted precisely.

### BRIEF DESCRIPTION OF THE DRAWINGS

This object, and other objects and advantages of the present invention, will appear more clearly from the following specification in conjunction with the accompanying schematic single drawing, which, not to scale, illustrates one exemplary embodiment of an inventive apparatus for carrying out the inventive method.

### SUMMARY OF THE INVENTION

The object of the invention is realized with an apparatus that is characterized primarily in that the winding wheel is connected with a motor by means of which the winding wheel can be driven or slowed, whereby at least two tensioning and guide rollers are radially spaced relative to the winding wheel such that the reinforcing element, which is guided over the winding wheel, forms a defined looping angle.

In addition, the object of the present invention is realized by a method characterized primarily in that the winding wheel, depending upon the desired tension of the reinforcing element, is slowed or driven, as a result of which a tension of 0-500 N, preferably 0-100 N, is applied to the reinforcing element.

The inventive apparatus and method are based on the surprising recognition that the previously described problems can be solved in that the reinforcing element can not only be slowed but can also be driven.

With this solution, the tension applied to the reinforcing element can be adjusted precisely; thus, there no longer results a “lagging behind” due to inertia that makes it very difficult to control an adjustment of tensions or the sequence tensioning/untensioning. If the reinforcing element is driven actively or passively, a thrust can be produced by means of which the reinforcing element, even during start up of the apparatus or carrying out of the method, can be wound onto the belt blank entirely without tension.

Pursuant to one advantageous further aspect of the invention, the reinforcing element that is guided over the winding wheel forms a looping angle of at least 180°.

Pursuant to a practical further embodiment of the invention, the motor can be a servomotor, and the sensors can be pressure or pivot sensors.

Pursuant to a further embodiment of the inventive method, the winding wheel can be driven at a greater speed than is the tire or belt build-up drum, as a result of which a controlled application of the reinforcing element entering upon the belt build-up drum is achieved.

Pursuant to a further embodiment of the inventive method, the ratio between speed of the tire or belt build-up drum and the speed of the winding wheel can be set such that the reinforcing element enters upon the tire or belt build-up drum at a speed of 1-300 m/min.

Further specific features of the present invention will be described in detail subsequently.

### DESCRIPTION OF PREFERRED EMBODIMENTS

Referring now to the drawing in detail, the apparatus 1 has a belt build-up drum 2, which is merely indicated, and upon which typically is supported a non-illustrated belt package, which comprises at least two belt plies. It is, however, especially for motorcycle tires, bicycle tires, or special tires, conceivable to directly wind upon a carcass ply a reinforcing element 3 that then serves as a belt.

Spaced from the surface 4 of the belt build-up drum 2 is a winding wheel 5 via which the reinforcing element 3 is guided in a frictional or positively engaging manner. Tensioning and guide rollers 6,7 are radially spaced relative to the surface 8 of the winding wheel 5 such that there results a looping angle of the reinforcing element 3 relative to the surface 8 of the winding wheel 5 of at least 180°. This has shown to be advantageous since only via this measure is an exact setting of tensioning of the reinforcing element 3 possible. Angle sensors can be used to ensure this angle, in particular, photoelectric angle sensors would be particularly useful.

The winding wheel 5 is connected to a non-illustrated servomotor by means of which the winding wheel 5 can be slowed or driven. A driving rotation of the winding wheel 5 results, in conjunction with the tensioning and guide rollers 6,7, in an advancement of the reinforcing element 3, so that the latter runs up on the belt build-up drum 2 without tension or even with thrust.

Operatively connected with the belt build-up drum 2 is a sensor arrangement 9, which comprises a pivot point sensor 10 and a pressure sensor 11. Pivot point sensors are well-known in the art and are distributed by, among other manufacturers, Warner Electric in the United States, www.warnernet.com. Such pivot point sensors typically are non-contact sensors utilizing a linear hall effect to provide a rotational position indication. Other electronic sensors known in the art such as those for measuring linear displacement of the beginning or other portion of the belt along its length or displacement side to side on the drum can also be utilized. The sensor arrangement 9 carries out a redundant force measurement; values that are obtained are conveyed directly to a control and regulating device that balances these values with prescribed desired or theoretical values and if necessary lowers (resulting in a slowing down of the reinforcing element) or raises the speed of the motor.

Further sensors could also be utilized. For example, the belt build-up drum 2 could also be provided with appropriate speed sensors, so that changes in speed could also be effected by correlation of the speeds of the belt build-up drum 2 and the winding wheel 5.

The specification incorporates by reference the disclosure of German priority document 101 60 249.9-16 filed 7 Dec. 2001.

The present invention is, of course, in no way restricted to the specific disclosure of the specification and drawing, but also encompasses any modifications within the scope of the appended claims.

We claim:

1. A method for helically winding a substantially strip-shaped reinforcing element onto at least one fabric ply of a pneumatic tire blank in which a reinforcing element is wound onto a rotating tire or a belt building drum via a winding wheel including the step of:
winding the reinforcing element onto a rotating tire or belt building drum via a winding wheel;
applying tensile forces to the reinforcing element, in particular by the reinforcing element being braked during winding onto the tire or belt building drum;
measuring the tensile force to the reinforcing element with tension sensors;
setting a tensile force of 0-500 N, preferably of 0-100 N to be applied to the reinforcing element;
maintaining or changing the tensile force in accordance with predetermined parameters wherein the winding wheel is braked or driven in dependence on the tensile force set for the reinforcing element; and
driving the winding wheel when the belt building drum is started up.

2. A method according to claim 1 including the further step of driving the winding wheel is operated at a higher speed than the tire or belt building drum, thereby achieving a controlled shirring of the reinforcing element impinging on the belt building drum.

3. A method according to claim 1 which includes the step of adjusting a ratio between a rotational speed of the tire or belt building drum and a rotational speed of the winding wheel such that the reinforcing element is applied to the tire or belt building drum at a speed of 1-300 m/min.

4. An apparatus for helically winding a substantially strip-shaped reinforcing element onto at least one fabric ply of a pneumatic tire blank, in which the reinforcing element is wound onto a rotating tire or belt building drum via a winding wheel, comprising:
a rotating tire or belt building drum;
a winding wheel disposed upstream of said tire or belt building drum and associated with means for applying tensile forces to said reinforcing element;
sensors which sense a lateral or linear position, angle, speed and/or displacement of said reinforcing element on said winding wheel and said tensile force applied to said reinforcing element and which sensors convey position, angle, speed, displacement, and/or tensile force measurements to a control device;
a motor for selectively driving or braking said winding wheel disposed in related connection to said winding wheel;
at least two tensioning and guiding rollers disposed at a radial distance from said winding wheel such that a reinforcing element disposed over the winding wheel forms a defined angle of wrap or looping angle when guided about said winding wheel.

5. An apparatus according to claim 4 wherein said reinforcing element forms an angle of at least 180°.

6. An apparatus according to claim 4 wherein said motor is a servo motor.

7. An apparatus according to claim 4 wherein at least one of said sensors is a pressure sensor spaced relative to said winding wheel.

8. An apparatus according to claim 4 wherein at least one sensor is a pivot sensor spaced relative to said winding wheel.

9. An apparatus according to claim 4 wherein at least one sensor is a speed sensor disposed on said winding wheel.

10. An apparatus according to claim 4 wherein at least one sensor is a displacement sensor spaced relative to said winding wheel.
